(19) United States
(12) Patent Application Publication
(10) Pub. No.: US 2026/0312769 A1
(43) Pub. Date: Oct. 8, 2026

(54) AI/ML BASED PUCCH SEQUENCE DESIGN FOR INTER-CELL SCENARIOS

(71) Applicant: QUALCOMM Incorporated, San Diego, CA (US)

(72) Inventors: Akash Sandeep DOSHI, San Diego, CA (US); June NAMGOONG, San Diego, CA (US); Yi HUANG, San Diego, CA (US); Wei YANG, San Diego, CA (US); Gabi SARKIS, San Diego, CA (US)

(21) Appl. No.: 19/636,697

(22) Filed: Apr. 1, 2026

Related U.S. Application Data
(60) Provisional application No. 63/782,392, filed on Apr. 2, 2025.

(51) Int. Cl. H04L 5/00; H04L 27/26

(52) U.S. Cl. CPC H04L 5/0053; H04L 27/26025

(57) ABSTRACT

This disclosure provides systems, methods and apparatuses for transmitting a physical channel such as a physical uplink control channel (PUCCH). A user equipment (UE) determines a mother sequence based on a network node and selects a sequence from a look up table based on an information message. For each transmission port, the user equipment generates a frequency domain sequence that satisfies a property of robustness to frequency selectivity based on the mother sequence, the selected sequence, and a phase shift that is independent of the information message. The user equipment then transmits the frequency domain sequence on each transmit port. The disclosed techniques can support transmission of a physical uplink control channel using port-specific sequence generation while maintaining robustness to frequency selective channel conditions.

### CROSS-REFERENCE TO RELATED APPLICATION

This application claims the benefit of U.S. Provisional Patent Application No. 63/782,392, entitled “AI/ML BASED PUCCH SEQUENCE DESIGN FOR INTER-CELL SCENARIOS”, filed on Apr. 2, 2025, which is expressly incorporated by reference herein in its entirety.

### TECHNICAL FIELD

The present disclosure relates to wireless communications including an artificial intelligence (AI) or machine learning (ML) based physical uplink control channel (PUCCH) design for inter-cell scenarios.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories, individually or in combination, having instructions; and one or more processors, individually or in combination, configured to execute the instructions and cause the apparatus to: determine a mother sequence based on a network node; select a frequency domain sequence from a look up table that satisfies a property of robustness to frequency selectivity; perform elementwise multiplication of the mother sequence and the selected frequency domain sequence per transmit port; and transmit a respective product sequence on each transmit port.

In some aspects, the techniques described herein relate to a method of wireless communication, including: determining a mother sequence based on a network node; selecting a frequency domain sequence from a look up table that satisfies a property of robustness to frequency selectivity; performing elementwise multiplication of the mother sequence and the selected frequency domain sequence per transmit port; and transmitting a respective product sequence on each transmit port.

In some aspects, the techniques described herein relate to an apparatus for wireless communication, including: means for determining a mother sequence based on a network node; means for selecting a frequency domain sequence from a look up table that satisfies a property of robustness to frequency selectivity; means for performing elementwise multiplication of the mother sequence and the selected frequency domain sequence per transmit port; and means for transmitting a respective product sequence on each transmit port.

In some aspects, the techniques described herein relate to an apparatus for wireless communication, including: one or more memories, individually or in combination, having instructions; and one or more processors, individually or in combination, configured to execute the instructions and cause the apparatus to: determine a mother sequence based on a network node; select a sequence from a look up table based on an information message; generate, per transmission port, a frequency domain sequence that satisfies a property of robustness to frequency selectivity based on the mother sequence, the sequence selected from the look up table, and a phase shift that is independent of the information message; and transmit the frequency domain sequence on each transmit port.

In some aspects, the techniques described herein relate to 9. A method of wireless communication, including: determining a mother sequence based on a network node; selecting a sequence from a look up table based on an information message; generating, per transmission port, a frequency domain sequence that satisfies a property of robustness to frequency selectivity based on the mother sequence, the sequence selected from the look up table, and a phase shift that is independent of the information message; and transmitting the frequency domain sequence on each transmit port.

In some aspects, the techniques described herein relate to an apparatus for wireless communication, including: means for determining a mother sequence based on a network node; means for selecting a sequence from a look up table based on an information message; means for generating, per transmission port, a frequency domain sequence that satisfies a property of robustness to frequency selectivity based on the mother sequence, the sequence selected from the look up table, and a phase shift that is independent of the information message; and means for transmitting the frequency domain sequence on each transmit port.

In some aspects, the techniques described herein relate to a method of wireless communication, including: descrambling a received sequence of a mother sequence elementwise multiplied with a received signal; performing energy detection on the received signal by cross correlating the descrambled signal with each frequency domain sequence in a look up table; identifying a closest correlated frequency domain sequence; and decoding the received sequence as bits corresponding to the closest correlated frequency domain sequence.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram illustrating an example of sequence generation for a sequence-based PUCCH transmission using a look up table.

FIG. 6 is a chart showing a complimentary cumulative distribution function (CCDF) of cross-correlation for the LUT based sequences described above in comparison to other techniques for sequence generation.

FIG. 7 is a message diagram illustrating various messages for PUCCH configuration with LUT based sequences.

FIG. 8 is a conceptual data flow diagram illustrating the data flow between different means/components in an example UE including a PUCCH Tx component.

FIG. 9 is a conceptual flow diagram illustrating the data flow between different means/components in an example network entity including a PUCCH Rx component.

FIG. 10 is a flowchart of an example method for a wireless node such as a UE to transmit a PUCCH based on a frequency domain sequence from a LUT.

FIG. 11 is a flowchart of an example method for a wireless node such as a network entity to receive a PUCCH based on a LUT based sequence.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology.

In wireless communications, sequence-base transmissions may be used to carry relatively small amounts of data. For example, some formats for a physical uplink control channel (PUCCH) utilize sequence based transmissions in which a sequence corresponding to a payload is transmitted over a number of resource elements and orthogonal frequency division multiplex (OFDM) symbols. Such sequence-based transmissions may utilize standardized definitions of sequences that have desirable properties such as low cross-correlation and low peak to average power (PAPR). For example, 3GPP TS 38.211 defines a set of low PAPR sequences, φ(n). Current designs for sequence-based transmissions such as 5G PUCCH may be limited in several ways. First, the sequences may be designed for a single transmit port. Accordingly, even if multiple transmit ports are available, a sequence based transmission may not take advantage of the available ports. Second, because the sequences are standardized, there may be room to improve performance based on a configuration of a network node that receives the sequence-based transmission. For example, standardized sequences may be received on network nodes with different numbers of receive antennas.

In an aspect, the present disclosure provides a PUCCH sequence design for inter-cell scenarios. For instance, a UE may transmit a PUCCH payload as a sequence over frequency-domain and time-domain resources. Further, the PUCCH sequence design provides for transmission over multiple transmit ports. A PUCCH sequence may be selected based on a mother sequence corresponding to a network node that the UE is connected to and a frequency-domain sequence selected from a look-up table (LUT). In some implementations, the LUT may be specific for the network node and may be based on the configuration of the network node. For instance, the LUT may be trained using artificial intelligence (AI) or machine-learning (ML) to have desirable properties for the network node. For example, the LUT may satisfy a low cross-correlation property. The low cross-correlation property may be better than a cyclic shift based sequence utilized in current 5G standards. However, a cyclic shift based sequence design may be easily implemented by shifting an inverse fast Fourier transform of the mother sequence in time. The PUCCH sequence design using the LUT may utilize elementwise multiplication of a method sequence and LUT sequence to maintain the low cross-correlation property.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

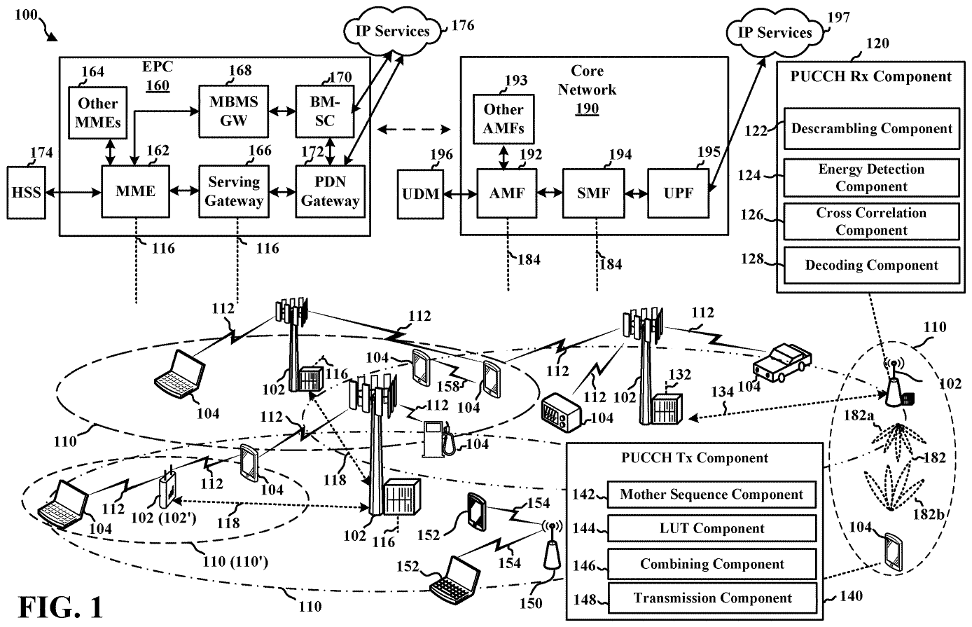

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as one or more central units (CUs) 188, one or more distributed units (DUs) 186, or a radio unit (RU) 180. Such architectures may be configured to utilize a protocol stack that is logically split between one or more units (such as one or more CUs and one or more DUs). In some aspects, the CUS 188 may be implemented within an edge RAN node, and in some aspects, one or more DUs 186 may be co-located with a CU 188, or may be geographically distributed throughout one or multiple RAN nodes. The DUs 186 may be implemented to communicate with one or more RUs 180.

In some implementations, one or more wireless nodes such as the UEs 104 include a PUCCH Tx component 140 configured to transmit a sequence-based PUCCH transmission based on a look up table. The PUCCH Tx component 140 includes a mother sequence component 142, a LUT component 144, a combining component 146, and a transmission component 148. The mother sequence component 142 is configured to determine a mother sequence based on a network node. The LUT component 144 is configured to select a frequency domain sequence from a look up table that satisfies a property of robustness to frequency selectivity. The combining component 146 is configured to perform elementwise multiplication of the mother sequence and the selected frequency domain sequence per transmit port. The transmission component 148 is configured to transmit a respective product sequence on each transmit port.

In some implementations, one or more of wireless nodes such as the network entities including a base station 102 may include a PUCCH Rx component 120. In particular, the PUCCH Rx component 120 is configured to receive a sequence based PUCCH transmission according to a look up table. The PUCCH Rx component 120 component 120 includes a descrambling component 122, an energy detection component 124, a cross-correlation component 126, and a decoding component 128. The descrambling component 122 is configured to descramble a received sequence of a mother sequence elementwise multiplied with a received signal. The energy detection component 124 is configured to perform energy detection on the received signal by cross correlating the descrambled signal with all the frequency domain sequences in a look up table. The cross-correlation component 126 is configured to identify a closest correlated frequency domain sequence. The decoding component 128 is configured to decode the received sequence as bits corresponding to the closest correlated frequency domain sequence.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 116 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 118 (such as X2 interface). The third backhaul links 118 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station may utilize beamforming 182 with the UE 104 to compensate for the path loss and short range. For example, the base station 102 may use beamforming 182 to transmit beams 182a and the UE 104 may utilize beamforming 182 to transmit beams 182b.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 6G, the concepts described herein may be applicable to other similar areas, such as 5G NR, LTE, LTE-A, CDMA, GSM, and other wireless technologies including future wireless technologies.

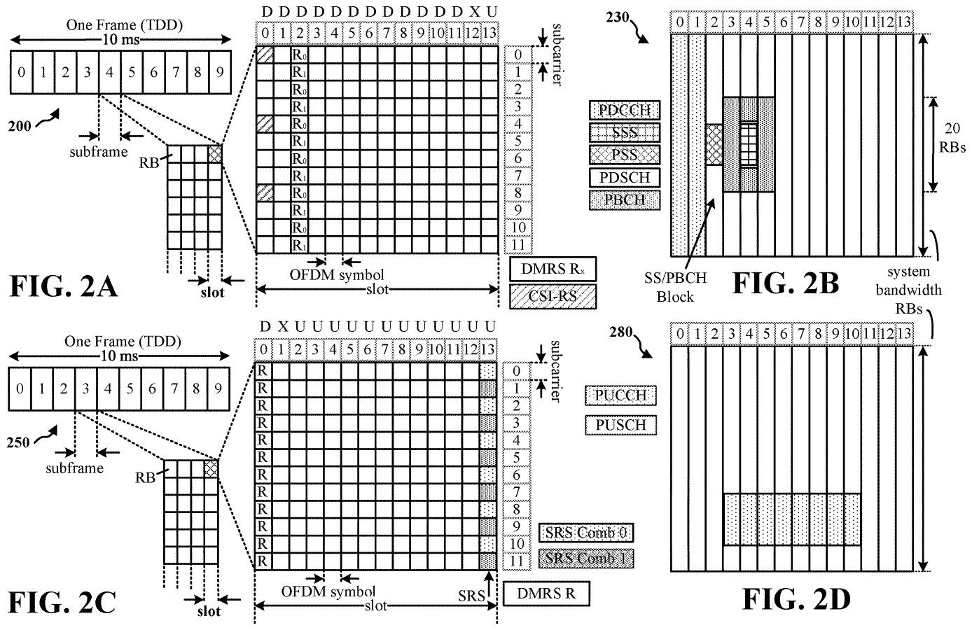

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rx for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

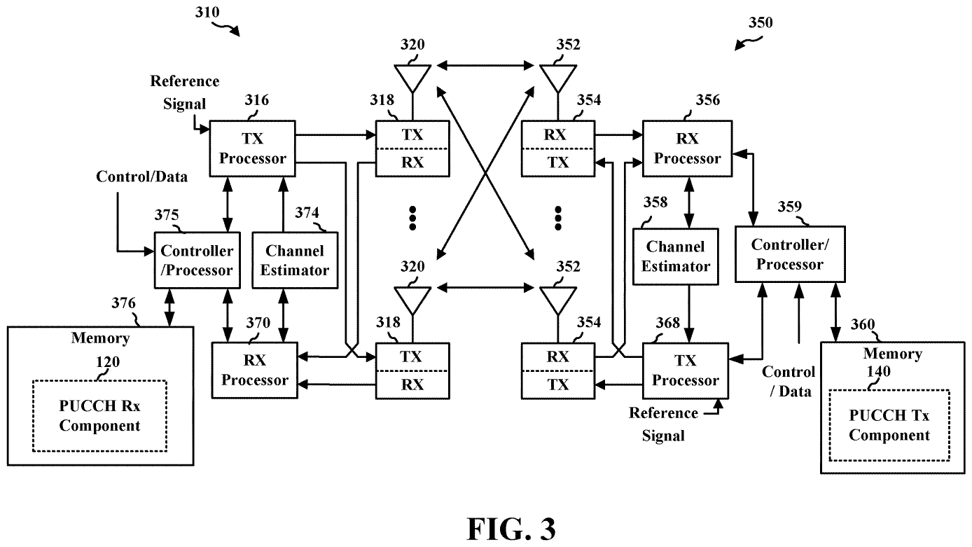

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission. In a split architecture, the transmitters/receivers 318 may be located in an RU 180, and the Tx processor 316, channel estimator 374, controller/processor 375, and Rx processor 370 may be located in a DU 186.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the PUCCH Tx component 140 of FIG. 1. For example, the memory 360 may include executable instructions defining the PUCCH Tx component 140. The TX processor 368, the RX processor 356, and/or the controller/processor 359 may be configured to execute the PUCCH Tx component 140.

At least one of the TX processor 316, the RX processor 370, and the controller/processor 375 may be configured to perform aspects in connection with the PUCCH Rx component 120 of FIG. 1. For example, the memory 376 may include executable instructions defining the PUCCH Rx component 120. The TX processor 316, the RX processor 370, and/or the controller/processor 375 may be configured to execute the PUCCH Rx component 120.

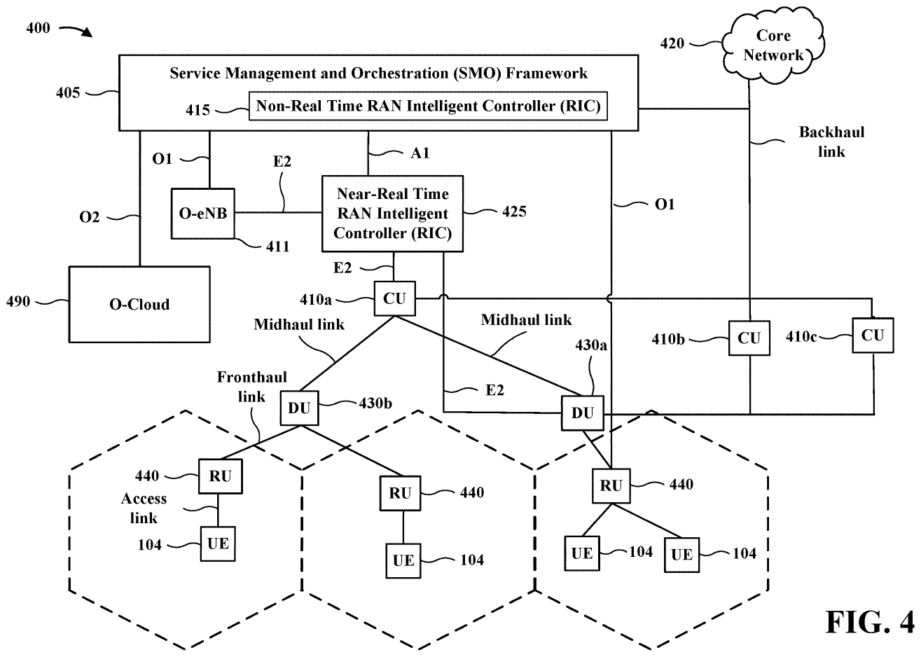

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

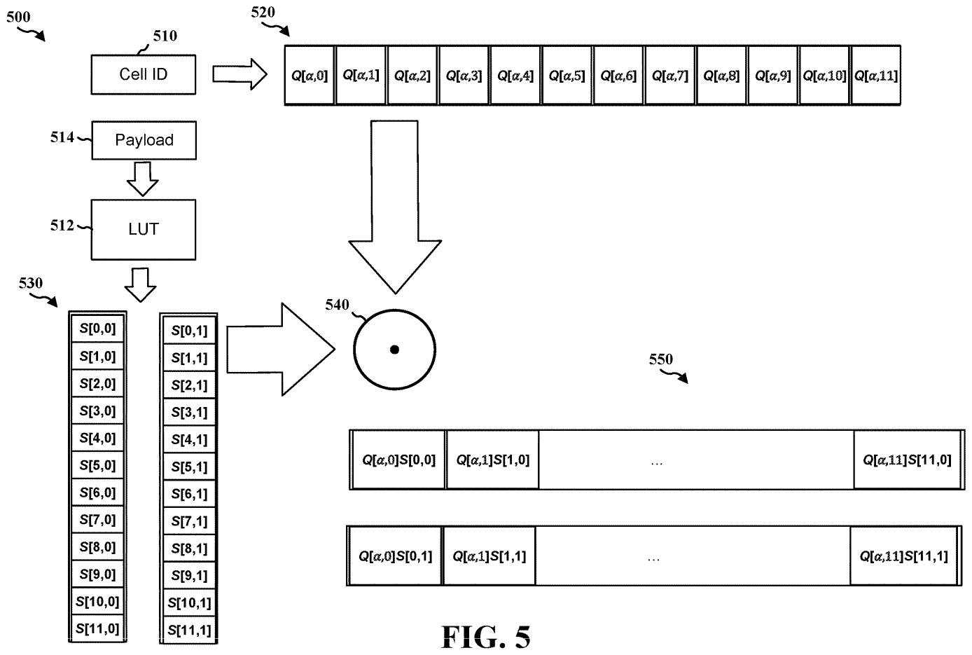

FIG. 5 is a diagram 500 illustrating an example of sequence generation for a sequence-based PUCCH transmission using a look up table. For example, a UE 104 may transmit a respective sequence 550 via one or more ports as a PUCCH transmission. The UE 104 may be configured with an identifier 510 (e.g., Cell ID) of a network node to which the UE 104 is connected. The UE 104 may also be configured with a look up table (LUT) 512, which may be specific to the network node. The UE 104 may have a payload 514 for transmission on a PUCCH. For example, the payload 514 may include one or more ACK/NACK bits and/or a scheduling request.

The UE 104 (e.g., the mother sequence component 142) may determine a mother sequence 520(Q) based on the identifier 510. For example, the mother sequence component 142 may apply the identifier 510 to a formula to determine the mother sequence 520. The mother sequence 520 may be pre-defined, for example, in a standards document or regulation. The mother sequence 520 may be designed as a low peak to average power ratio (PAPR) quadrature phase shift keying (QPSK) sequence. The mother sequence 520, being selected based on the network node, can be distinguished from signals transmitted for other cells and mitigate inter-cell interference. In an aspect, the mother sequence 520 may have a length based on the transmission resources. For instance, the length may be N_{f}×Nₜ, where N_{f} is the number of resource elements (REs) and Nₜ is the number of OFDM symbols. For simplicity, a PUCCH format 0 transmission on 1 resource block (RB) of 12 REs and 1 OFDM symbol is illustrated. The techniques disclosed herein may be applicable to other sequence based transmissions such as PUCCH format 1, 3, and 4. In an aspect, the identifier 510 may be constrained or modulo reduced for limited mother sequences. In an aspect, Q ∈ [symbol] ^{30×NfNt}. That is, the mother sequence may be selected from a set (e.g., of 30) possible mother sequences.

The UE 104 (e.g., the LUT component 144) may select a frequency domain sequence 530 from the LUT 512. The LUT 512 may satisfy one or more desired transmission properties. For example, the LUT 512 may have a property of robustness to frequency selectivity. As another example, the LUT 512 may have a low cross-correlation property between sequences. In some implementations, the LUT 512 is specific for the network node to which the UE 104 is connected. For example, the network node may signal the LUT 512 to the UE, for example, in a PUCCH configuration message using radio resource control (RRC) signaling or a media access control (MAC) control element (CE). In some implementations, the LUT 512 is trained for the network node using a machine-learning technique to be robust to high channel frequency selectivity. The LUT 512 may depend on a configuration of the network node (e.g., a gNB).

The LUT 512 provides the frequency domain sequence 530 corresponding to the payload 514. The payload 514 may be considered a message vector of k bits. The frequency domain sequence 530 may be a codeword of N_{f}Nₜ×Nₛ complex numbers, where Nₛ refers to a number of transmit ports. That is, the frequency domain sequence 530 includes values for N_{f}Nₜ REs per port. For example, the frequency domain sequence 530 for two transmit ports is illustrated. A codebook S for the frequency domain sequence 530 includes 2^{k}×2N_{f}NₛNₜ real values. The LUT 512 maps the message vector corresponding to the payload 514 to a codeword in the codebook S.

The UE 104 (e.g., the combining component 146) generates a frequency domain sequence that satisfies a property of robustness to frequency selectivity based on the mother sequence, the sequence selected from the look up table, and a phase shift that is independent of the information message. For example, the frequency domain sequence may be defined by the following equation:

$${r}_{u , v}^{( α , δ )} ( n ) = {e}^{j α n} {s}_{i} ( n ) {\overline{r}}_{u , v} ( n )$$

where e^{jan} is a cyclic shift, sᵢ(n) is the respective codeword from the look up table, and r̅_{u,v}(n) is the mother sequence. More specifically, in some implementations, Sᵢ={sᵢ(n)}ₙ and is a function of the PUCCH payload. In some implementations, the cyclic shift e^{jan} is a function of the symbol and slot number, but is independent of the payload. For example, in some implementations, αₗ is defined by the following equation:

$${α}_{l} = \frac{2 π}{{N}_{s c}^{R B}} ( ( {m}_{0} + {m}_{i n t} + {n}_{c s} ( {n}_{s , f}^{μ} , l + {l}^{′} ) ) mod {N}_{sc}^{RB} )$$

In some implementations, to generate the frequency domain sequence, the UE 104 (e.g., the combining component 146) performs elementwise multiplication 540 of the mother sequence 520 and the selected frequency domain sequence 530 per transmit port to generate the product sequence 550. The product sequence 550 includes N_{f}Nₜ×Nₛ elements. Each element of the product sequence 550 is a product of an element of the mother sequence 520 and an element of the frequency domain sequence 530. The transmission component 148 may transmit the product sequence 550 on the resources allocated for the PUCCH transmission. The product sequence 550(P) may be expressed as:

$$P = Q [ α , : ] ⊙ {S}_{i} [ : , l ] = [ Q [ α , 0 ] {S}_{i} [ 0 , l ] , Q [ α , 1 ] {S}_{i} [ 1 , l ] , … Q [ α , {N}_{f} {N}_{t} - 1 ] {S}_{i} [ {N}_{f} {N}_{t} - 1 , l ] ]$$

where l is an index of the transmit port. In some implementations, Q[α,:] includes the cyclic shift e^{jan}, which may be a scalar phase rotation that is independent of the sequence selected.

In the case of a single OFDM symbol and a single transmit port, the expression can be simplified to:

$$Q [ 0 , : ] ⊙ {S}_{i} [ : , 0 ] = [ Q [ 0 , 0 ] {S}_{i} [ 0 , 0 ] , Q [ 0 , 1 ] {S}_{i} [ 1 , 0 ] , … Q [ 0 , {N}_{f} - 1 ] {S}_{i} [ {N}_{f} - 1 , 0 ] ]$$

At the network node, a received signal (Y) of the product sequence 550 may be expressed as:

$$Y [ : , j ] = {\sum }_{l = 0}^{{N}_{s}} H [ : , j , l ] ⊙ Q [ α , : ] ⊙ {S}_{i} [ : , l ] + N [ : , j ] ,$$

where Y ∈ [symbol] ^{NfNt×Nr}, H ∈ [symbol] ^{NfNt×Nr×Ns}, Si ∈ [symbol] ^{NfNt×Ns}, N ∈ [symbol] ^{NfNt×Nr} and S ∈{S₀, . . . . S₂ₖ₋₁}. Q[α,:] is a QPSK sequence corresponding to cell site α (i.e., the network node). H represents the channel and j is an index of the RE.

The network node may obtain the payload by descrambling the received signal, performing energy detection, identifying a strongest correlation to a codebook sequence, and looking up the corresponding message vector. For instance, the descrambling component 122 may descramble Q*[α,:]⊙Y[:,j]. The energy detection component 124 may perform energy detection by computing by

$${p}_{i} = {\sum }_{j = 0}^{{N}_{r}} {\sum }_{l = 0}^{{N}_{s}} {‖ {S [ : , l ]}_{k}^{H} ( {Q}^{*} [ α , : ] ⊙ Y [ : , j ] ) ‖}^{2} ∀ i ∈ \{ 0 , 1 , … {2}^{k} - 1 \} .$$

The cross-correlation component 126 may identify i*=arg maxpᵢ as the closest correlated frequency domain sequence of the codebook. The decoding component 128 may then identify the decoded message vector based on the correlated frequency domain sequence of the codebook, for example, using the LUT 512.

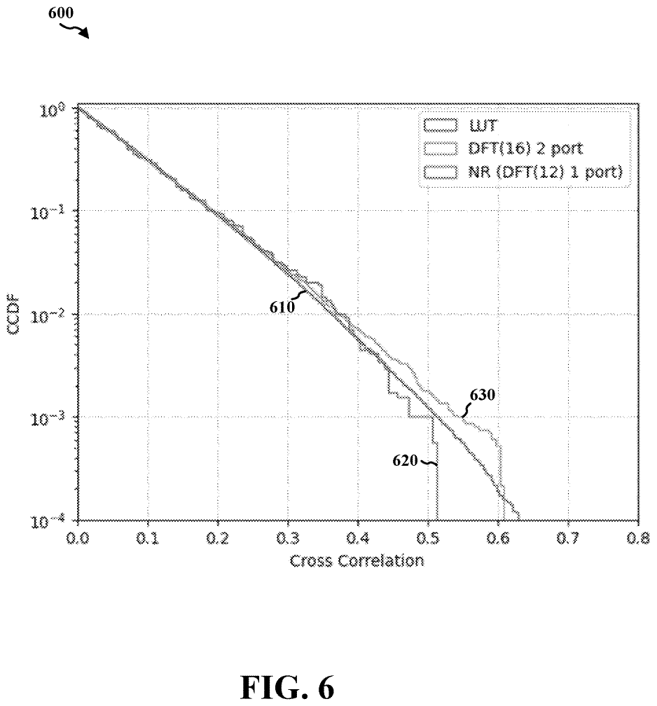

FIG. 6 is a chart 600 showing a complimentary cumulative distribution function (CCDF) of cross-correlation for the LUT based sequences 610 described above in comparison to other techniques for sequence generation.

A goal of a sequence based transmission is to maintain a low cross-correlation between sequences across cells. Inter-cell interference can be considered of the following form (setting Nₛ=Nₜ=1 and Nᵣₓ=1 for notational simplicity):

$$Y = H ⊙ Q [ α , : ] ⊙ {S}_{i} + {H}^{′} ⊙ Q [ {α}^{′} , : ] ⊙ {S}_{j} + N$$

Orthogonality (or low cross-correlation) is studied for frequency flat, high SNR scenarios, hence it can be assumed Y=Q[α,:]⊙ Sᵢ+Q[α′,:] ⊙ Sⱼ.

The inter-cell interfering signal is unlikely to be synchronized with the desired signal. To model this delay τ′, a phase ramp is introduced in the frequency domain as

$$Y = Q [ α , : ] ⊙ {S}_{i} + Q [ {α}^{′} , : ] ⊙ {[ 1 {e}^{j 2 π Δ f {τ}^{′}} … {e}^{j 2 ( {N}_{f} - 1 ) π Δ f {τ}^{′}} ]}^{T} ⊙ {S}_{j}$$

To successfully decode Sᵢ, the receiving network node needs

$${‖ {S}_{k}^{H} ( {Q}^{*} [ α , : ] ⊙ Q [ {α}^{′} , : ] ⊙ {[ 1 {e}^{j 2 π Δ f {τ}^{′}} … {e}^{j 2 ( {N}_{f} - 1 ) π Δ f {τ}^{′}} ]}^{T} ⊙ {S}_{j} ) ‖}^{2}$$

to be low for all α′≠α, j ∈ [2^{k}] and k≠i. That is, there should be low cross-correlation between the received signals using different mother sequences.

For comparison, a NR(DFT(12) 1 port) scheme 620 (e.g., 3GPP NR Release 18 PUCCH format 0) utilizes rows of a DFT (12) matrix to transmit PUCCH format 0. For transmitting 3 bits, 2 HARQ-ACK+1 SR, NR utilizes the {1,2,4,5,7,8, 10,11} th row.

An example extension of the NR scheme 630 to two ports may use a DFT (16) matrix. For example with k=3 and Nₛ=2, Consider a 2^{k}×Nₛ (16) DFT matrix is 16×16. The UE may select the first N_{f} (12) rows (i.e., a 12×16 matrix). The UE may append the 1st column to the 2^{k}+1 (9) column, 2nd column to the 2^{k}+2 (10) and so on to generate a 8×24 matrix, where the 8 rows correspond to the 8 codewords and the 24 elements in the selected row can be mapped to 12 REs on 2 ports.

In the illustrated example, a LUT of size 2^{k}×12 is learnable. k=3 for 3 bit PUCCH 0 payload. The LUT may be trained over a channel with a uniform power delay profile (PDP) and an optimum bitwise receiver with center of mass (COM) adjustment.

The chart 600 shows the cross-correlation for the three methods described above. The chart 600 shows that the LUT does not have a significant negative impact on cross-correlation across cells. That is, the combining the LUT sequences with the mother sequence rather than a cyclic shift sequence does not reduce the ability to distinguish between signals for different cells. Further, in some ranges, the LUT sequence exhibits less cross-correlation than either the 3GPP Release 18 PUCCH sequence and an extension of the 3GPP Release 18 PUCCH sequence to 2 transmit ports. In particular, from about 10⁻¹ to about 10⁻², the cross-correlation of the LUT sequence is lower than the other sequences. Although the tail (less than 1% probability) includes some values with higher correlation than the 3GPP Release 18 PUCCH sequence, the LUT sequence has lower cross-correlation than the extension of the 3GPP Release 18 PUCCH sequence to two ports.

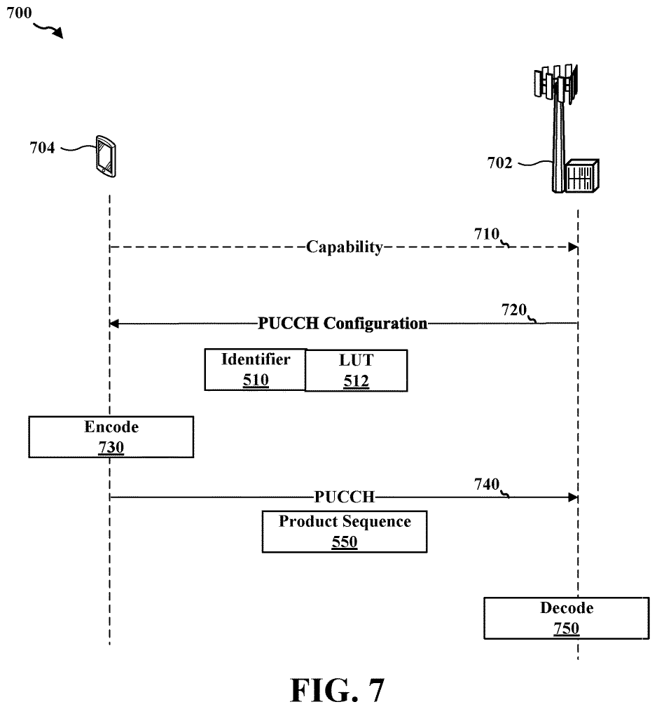

FIG. 7 is a message diagram 700 illustrating various messages for PUCCH configuration with LUT based sequences. A wireless node such as a UE 704 may be configured with a PUCCH configuration that can be used to transmit a PUCCH. A wireless node such as a network node 702 may configure the UE 704 and receive the PUCCH.

In some implementations, the UE 804 may transmit a capability message 710 that indicates a capability associated with LUT based PUCCH transmission.

The network node 702 may transmit a PUCCH configuration 720 that defines a plurality the identifier 510 of the network node 702 and/or the LUT 512 for the network node 702. For instance, the PUCCH configuration 720 may be an RRC message or a MAC-CE.

At block 730, the UE 704 may encode a PUCCH payload as a product sequence 550 based on a mother sequence 520 and a selected frequency domain sequence 530. The UE 704 may transmit the product sequence 550 on PUCCH resources as a PUCCH 740.

At block 750, the network node 702 may perform a decode operation, which may include descrambling, energy detection based on cross-correlation, identifying a strongest correlation, and obtaining decoded bits.

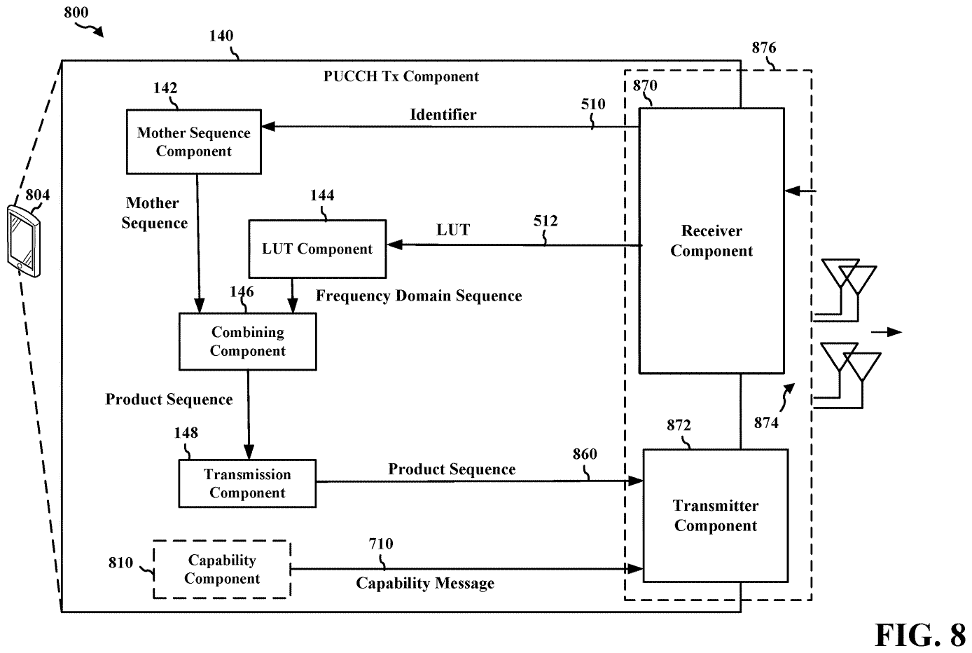

FIG. 8 is a conceptual data flow diagram 800 illustrating the data flow between different means/components in an example UE 804 including a PUCCH Tx component 140. For example, the UE 804 may be an example of a wireless node such as the UE 104 (FIG. 1) including the PUCCH Tx component 140. The PUCCH Tx component 140 may be implemented by the memory 360 and the TX processor 368, the RX processor 356, and/or the controller/processor 368 of FIG. 3. For example, the memory 360 may store executable instructions defining the PUCCH Tx component 140 and the TX processor 368, the RX processor 356, and/or the controller/processor 359 may execute the instructions.

The UE 804 may include a receiver component 870, which may include, for example, a radio frequency (RF) receiver for receiving the signals described herein. The UE 804 may include a transmitter component 872, which may include, for example, an RF transmitter for transmitting the signals described herein. The transmitter component 872 may output RF signals to one or more antennas 874. In an aspect, the transmitter component 872 may be co-located in a transceiver 876, which may correspond to the TX/RX 354 in FIG. 3.

As discussed with respect to FIG. 1, the PUCCH Tx component 140 may include the mother sequence component 142, a LUT component 144, a combining component 146, and a transmission component 148. In some implementations, the PUCCH Tx component 140 may optionally include a capability component 810.

The receiver component 870 may receive signals from a network node such as a base station 102. For example, the receiver component 870 may receive the PUCCH configuration 720. The receiver component 1070 may provide the PUCCH configuration 720 to the mother sequence component 142 and/or the LUT component 144.

In some implementations, the optional capability component 810 may be configured to output for transmission a capability associated with LUT based sequence transmissions. For example, the capability component 810 may output the capability message 710 as an RRC message for transmission by the transmitter component 872.

The mother sequence component 142 may obtain the identifier 510 via the receiver component 870. The mother sequence component 142 determines the mother sequence 520(Q) based on the identifier 510 of the network node. The mother sequence component 142 may generate a number of elements of the mother sequence based on the PUCCH resources for transmitting a PUCCH payload 514. The mother sequence component 142 may output the mother sequence 520 to the combining component 146.

The LUT component 144 may obtain the LUT 512 via the receiver component 870. The LUT component 144 selects a frequency domain sequence from the LUT 512, which satisfies a property of robustness to frequency selectivity. For instance, the LUT component 144 can look up an input vector of k bits corresponding to the payload 514 in the LUT 512 to obtain the frequency domain sequence 530. The LUT component 144 may output the selected frequency domain sequence 530 to the combining component 146.

The combining component 146 obtains the mother sequence 520 from the mother sequence component 142 and obtains the selected frequency domain sequence 530 from the LUT component 144. The combining component 146 performs elementwise multiplication 540 of the mother sequence 520 and the selected frequency domain sequence 530 per transmit port. For instance, the combining component 146 produces a respective product sequence 550 for each transmit port. The combining component 146 outputs the respective product sequence 550 to the transmission component 148.

The transmission component 148 obtains the respective product sequence(s) 550 from the combining component 146. The transmission component 148 is configured to transmit the respective product sequence 550 on each transmit port. For instance, the transmission component 148 may output the respective product sequence 550 to each transmit port of the transmitter component 872.

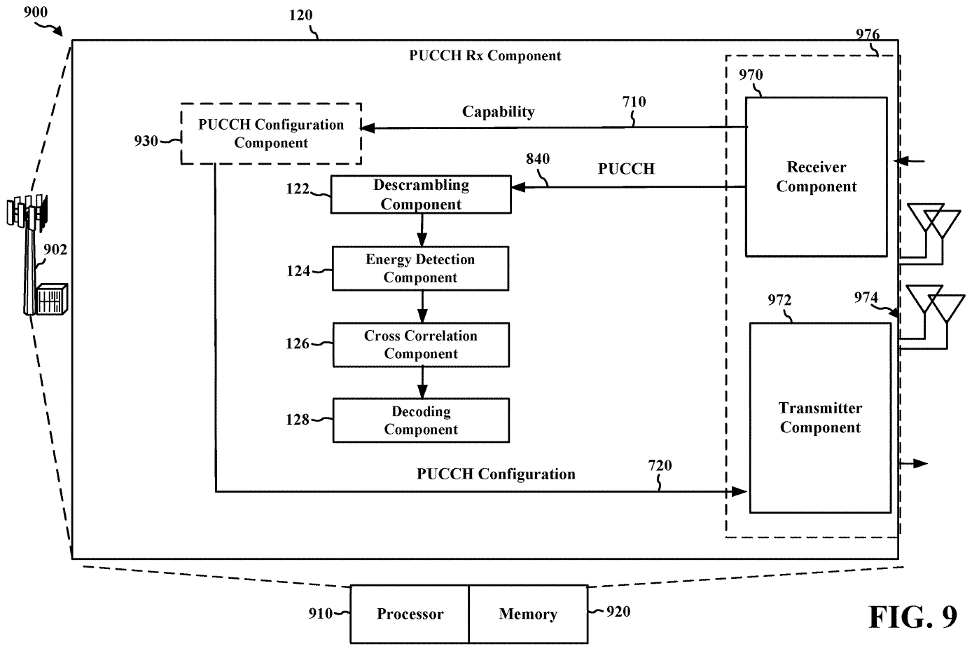

FIG. 9 is a conceptual flow diagram 900 illustrating the data flow between different means/components in an example network entity 902 including a PUCCH Rx component 120. For example, the network entity 902 may be an example of a network node such as the base station 102 (FIG. 1) including the PUCCH Rx component 120. In some implementations, the PUCCH Rx component 120 may be implemented by the memory 376 and the TX processor 316, the RX processor 370, and/or the controller/processor 375 of FIG. 3. For example, the memory 376 may store executable instructions defining the PUCCH Rx component 120 and the TX processor 316, the RX processor 370, and/or the controller/processor 375 may execute the instructions. In other implementations, the PUCCH Rx component 120 may be implemented on computing resources including one or more processors 910 and one or more memories 920. For example, the PUCCH Rx component 120 may be implemented on a virtual DU in a datacenter.

As discussed with respect to FIG. 1, the PUCCH Rx component 120 may include the descrambling component 122, the energy detection component 124, the cross-correlation component 126, and the decoding component 128. The PUCCH Rx component 120 may optionally include a PUCCH configuration component 930.

The network entity 902 may include a receiver component 970, which may include, for example, a radio frequency (RF) receiver for receiving the signals described herein. For example, receiver component 970 may receive the capability message 710 and the PUCCH 740. The network entity 902 may include a transmitter component 972, which may include, for example, an RF transmitter for transmitting the signals described herein. The transmitter component 972 may output RF signals to one or more antennas 974. In an aspect, the receiver component 970 and the transmitter component 972 may be co-located in a transceiver 976, which may correspond to the TX/RX 318 in FIG. 3.

The PUCCH Rx component 120 may obtain a capability message 710 via the receiver component 970. If the capability message 710 indicates a capability for LUT based sequence transmission, the PUCCH Rx component 120 may output a PUCCH configuration 720 for transmission via the transmitter component 972.

The descrambling component 122 may obtain the PUCCH 740 via the receiver component 970. The descrambling component 122 descrambles a received sequence of a mother sequence elementwise multiplied with a received signal. The descrambling component 122 uses the mother sequence 520 corresponding to the network entity 902 to descramble the received signal Y. The descrambling component 122 outputs the descrambled signal to the energy detection component 124.

The energy detection component 124 obtains the descrambled signal from the descrambling component 122. The energy detection component 124 performs energy detection on the received signal by cross correlating the descrambled signal with all the frequency domain sequences in the LUT 512. The energy detection provides a correlation strength for each frequency domain signal. The energy detection component 124 outputs the correlation strength (p) to the cross-correlation component 126.

The cross-correlation component 126 obtains the correlation strengths from the energy detection component 124. The cross-correlation component 126 identifies a closest correlated frequency domain sequence. For instance, the cross-correlation component 126 computes i*=arg max pᵢ. The cross-correlation component 126 may output an index (i) of the closest correlated frequency domain sequence to the decoding component 128.

The decoding component 128 obtains the index of the closest correlated frequency domain sequence from the cross-correlation component 126. The decoding component 128 decodes the received sequence as bits corresponding to the closest correlated frequency domain sequence. For instance, the decoding component 128 may use the LUT 512 to look up the k bits corresponding to the closest correlated frequency domain sequence. In some implementations, the index is the same as the k bits.

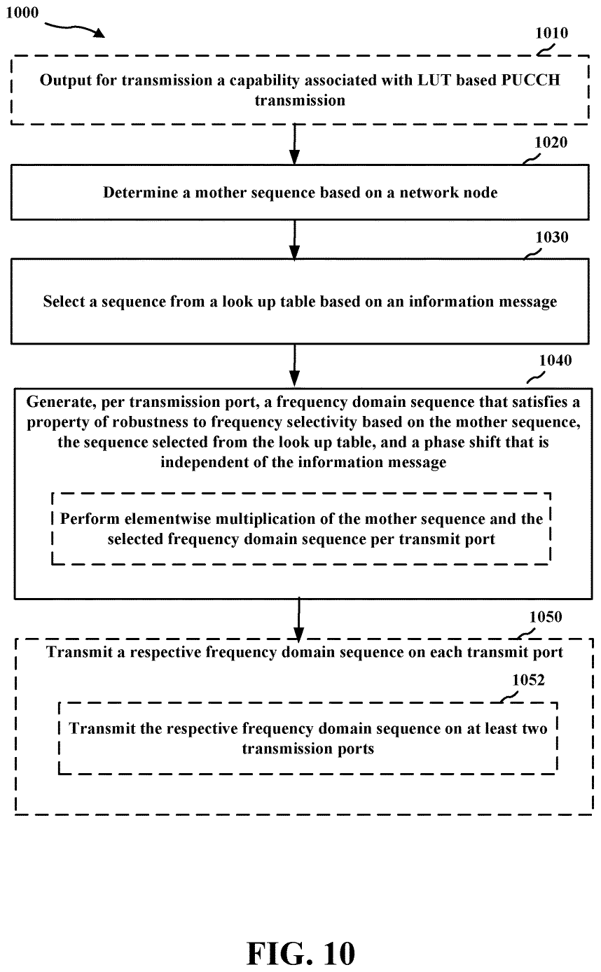

FIG. 10 is a flowchart of an example method 1000 for a wireless node such as a UE to transmit a PUCCH based on a frequency domain sequence from a LUT. The method 1000 may be performed by a UE (such as the UE 104, which may include the memory 360 and which may be the entire UE 104 or a component of the UE 104 such as the PUCCH Tx component 140, TX processor 368, the RX processor 356, or the controller/processor 359). The method 1000 may be performed by the PUCCH Tx component 140 in communication with the PUCCH Rx component 120 at a network entity. Optional blocks are shown with dashed lines.

At block 1010, the method 1000 may optionally include outputting for transmission a capability associated with LUT based PUCCH transmission. In some implementations, for example, the UE 104, the TX processor 368 or the controller/processor 359 may execute the PUCCH Tx component 140 or the capability component 810 to output for transmission a capability message 710 associated with LUT based PUCCH transmission. Accordingly, the UE 104, the TX processor 368, or the controller/processor 359 executing the PUCCH Tx component 140 or the capability component 810 may provide means for outputting for transmission a capability associated with LUT based PUCCH transmission.

At block 1020, the method 1000 includes determining a mother sequence based on a network node. In some implementations, for example, the UE 104, the RX processor 356 or the controller/processor 359 may execute the PUCCH Tx component 140 or the mother sequence component 142 to determine a mother sequence 520 based on the network node. In some implementations, the mother sequence is selected from a pre-defined set of low PAPR QPSK sequences based on an identifier of the network node. Accordingly, the UE 104, the RX processor 359, or the controller/processor 359 executing the PUCCH Tx component 140 or the mother sequence component 142 may provide means for determining a mother sequence based on a network node.

At block 1030, the method 1000 includes selecting a sequence from a look up table based on an information message. In some implementations, for example, the UE 104, the RX processor 356 or the controller/processor 359 may execute the PUCCH Tx component 140 or the LUT component 144 to select the sequence 530 from the look up table (LUT 512) based on the information message (e.g., the PUCCH content). In some implementations, the look up table is trained for the network node using a machine-learning technique to be robust to high channel frequency selectivity. In some implementations, the frequency domain sequences have a property of low cross-correlation. In some implementations, the frequency domain sequence has a number of elements equal to a number of resource elements times a number of OFDM symbols for the transmission times a number of transmit ports. In some implementations, the LUT component 144 selects the frequency domain sequence from the look up table is based on a payload 514 of a PUCCH for transmission. Accordingly, the UE 104, the RX processor 359, or the controller/processor 359 executing the PUCCH Tx component 140 or the LUT component 144 may provide means for selecting a frequency domain sequence from a look up table that satisfies a property of robustness to frequency selectivity.

At block 1040, the method 1000 includes generating, per transmission port, a frequency domain sequence that satisfies a property of robustness to frequency selectivity based on the mother sequence, the sequence selected from the look up table, and a phase shift that is independent of the information message. In some implementations, for example, the UE 104, the RX processor 356 or the controller/processor 359 may execute the PUCCH Tx component 140 or the combining component 146 to generate, per transmission port, a frequency domain sequence that satisfies a property of robustness to frequency selectivity based on the mother sequence, the sequence selected from the look up table, and a phase shift that is independent of the information message. In some implementations, at sub-block 1042, the PUCCH Tx component 140 or the combining component 146 performs elementwise multiplication 540 of the mother sequence 520 and the selected frequency domain sequence 530 per transmit port. In some implementations, the product sequence for a transmission on a single OFDM symbol on a single transmission port is an element wise multiplication of a single row mother sequence times a single column frequency domain sequence. Accordingly, the UE 104, the RX processor 359, or the controller/processor 359 executing the PUCCH Tx component 140 or the combining component 146 may provide means for generating, per transmission port, a frequency domain sequence that satisfies a property of robustness to frequency selectivity based on the mother sequence, the sequence selected from the look up table, and a phase shift that is independent of the information message.

At block 1050, the method 1000 includes transmitting a respective frequency domain sequence on each transmit port. In some implementations, for example, the UE 104, the TX processor 368 or the controller/processor 359 may execute the PUCCH Tx component 140 or the transmission component 148 to transmit a respective frequency domain sequence on each transmit port. In some implementations, at sub-block 1052, the block 1050 may optionally include transmitting the respective frequency domain sequence on at least two transmission ports. Accordingly, the UE 104, the TX processor 368, or the controller/processor 359 executing the PUCCH Tx component 140 or the transmission component 148 may provide means for transmitting a respective frequency domain sequence on each transmit port.

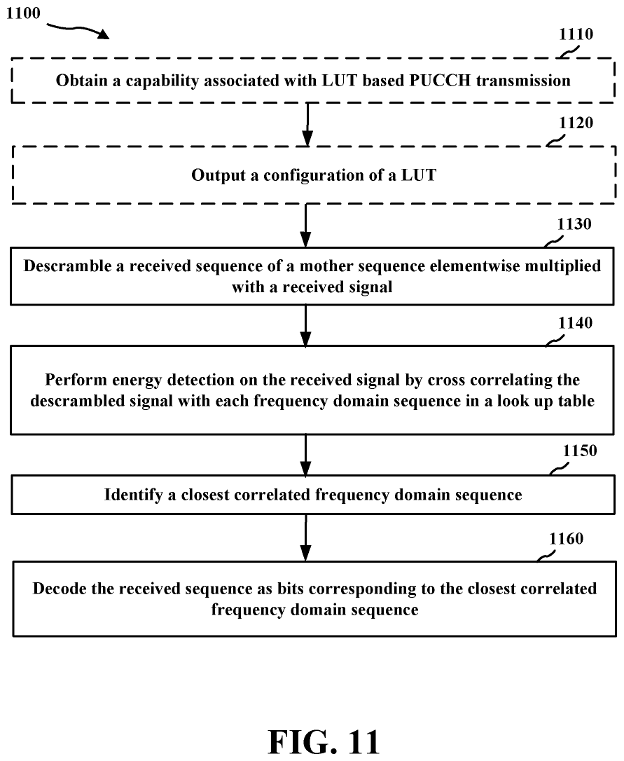

FIG. 11 is a flowchart of an example method 1100 for a wireless node such as a network entity to receive a PUCCH based on a LUT based sequence. The method 1100 may be performed by a network entity (such as the base station 102, which may include the memory 376 and which may be the entire base station 102 or a component of the base station such as the PUCCH Rx component 120, TX processor 316, the RX processor 370, or the controller/processor 375). The method 1100 may be performed by the PUCCH Rx component 120 in communication with the PUCCH Tx component 140 at a UE. Optional blocks are shown with dashed lines.

At block 1110, the method 1100 may optionally include obtaining a capability associated with LUT based PUCCH transmission. In some implementations, for example, the base station 102, the RX processor 370 or the controller/processor 375 may execute the PUCCH Rx component 120 or the PUCCH configuration component 930 to obtain a capability associated with LUT based PUCCH transmission. Accordingly, the base station 102, the RX processor 370, or the controller/processor 375 executing the PUCCH Rx component 120 or the PUCCH configuration component 930 may provide means for obtaining a capability associated with LUT based PUCCH transmission.

At block 1120, the method 1100 may optionally include outputting a configuration of a LUT. In some implementations, for example, the base station 102, the TX processor 316 or the controller/processor 375 may execute the PUCCH Rx component 120 or the PUCCH configuration component 930 to output a configuration of a LUT 512.

Accordingly, the base station 102, the TX processor 316, or the controller/processor 375 executing the PUCCH Rx component 120 or the PUCCH configuration component 930 may provide means for outputting a configuration of a LUT.

At block 1130, the method 1100 includes descrambling a received sequence of a mother sequence elementwise multiplied with a received signal. In some implementations, for example, the base station 102, the TX processor 316 or the controller/processor 375 may execute the PUCCH Rx component 120 or the descrambling component 122 to descramble a received sequence of a mother sequence elementwise multiplied with a received signal. Accordingly, the base station 102, the TX processor 316, or the controller/processor 375 executing the PUCCH Rx component 120 or the descrambling component 122 may provide means for descrambling a received sequence of a mother sequence elementwise multiplied with a received signal.

At block 1140, the method 1100 includes performing energy detection on the received signal by cross correlating the descrambled signal with each frequency domain sequence in a look up table. In some implementations, for example, the base station 102, the TX processor 316 or the controller/processor 375 may execute the PUCCH Rx component 120 or the energy detection component 124 to perform energy detection on the received signal by cross correlating the descrambled signal with each frequency domain sequence in a look up table. Accordingly, the base station 102, the TX processor 316, or the controller/processor 375 executing the PUCCH Rx component 120 or the energy detection component 124 may provide means for performing energy detection on the received signal by cross correlating the descrambled signal with each frequency domain sequence in a look up table.

At block 1150, the method 1100 includes identifying a closest correlated frequency domain sequence. In some implementations, for example, the base station 102, the RX processor 370 or the controller/processor 375 may execute the PUCCH Rx component 120 or the cross-correlation component 126 to identify a closest correlated frequency domain sequence. Accordingly, the base station 102, the RX processor 370, or the controller/processor 375 executing the PUCCH Rx component 120 or the cross-correlation component 126 may provide means for identifying a closest correlated frequency domain sequence.

At block 1160, the method 1100 includes decoding the received sequence as bits corresponding to the closest correlated frequency domain sequence. In some implementations, for example, the base station 102, the RX processor 370 or the controller/processor 375 may execute the PUCCH Rx component 120 or the decoding component 128 to decoding the received sequence as bits corresponding to the closest correlated frequency domain sequence. Accordingly, the base station 102, the RX processor 370, or the controller/processor 375 executing the PUCCH Rx component 120 or the decoding component 128 may provide means for decoding the received sequence as bits corresponding to the closest correlated frequency domain sequence.

In some cases, rather than actually transmitting a message, a device may have an interface to output a message for transmission (a means for outputting). For example, a processor may output a message, via a bus interface, to a radio frequency (RF) front end for transmission. Similarly, rather than actually receiving a message, a device may have an interface to obtain a message received from another device (a means for obtaining). For example, a processor may obtain (or receive) a message, via a bus interface, from an RF front end for reception. In some cases, the interface to output a message for transmission and the interface to obtain a message (which may be referred to as first and second interfaces herein) may be the same interface.

Means for obtaining, means for outputting, means for determining, means for selecting, means for performing, means for descrambling, means for identifying, and/or means for decoding, may include any of the various processors and/or memories shown in FIG. 3. Means for receiving and/or means for transmitting may include any of the various processors, memories, and/or transceivers shown in FIG. 3.

The following numbered examples provide an overview of aspects of the present disclosure:
Clause 1. An apparatus for wireless communication, comprising: one or more memories, individually or in combination, having instructions; and one or more processors, individually or in combination, configured to execute the instructions and cause the apparatus to: determine a mother sequence based on a network node; select a sequence from a look up table based on an information message; generate, per transmission port, a frequency domain sequence that satisfies a property of robustness to frequency selectivity based on the mother sequence, the sequence selected from the look up table, and a phase shift that is independent of the information message; and transmit the frequency domain sequence on each transmit port.
Clause 2. The apparatus of clause 1, wherein to generate the frequency domain sequence, the one or more processors are configured to execute the instructions to perform elementwise multiplication of the mother sequence and the selected sequence per transmit port.
Clause 3. The apparatus of clause 1 or 2, wherein the look up table is trained for the network node using a machine-learning technique to be robust to high channel frequency selectivity.
Clause 4. The apparatus of any of clauses 1-3, wherein to transmit the frequency domain sequence, the one or more processors are configured to execute the instructions to transmit a respective frequency domain sequence on at least two transmission ports, wherein each respective frequency domain sequence is based on a selected sequence per transmit port.
Clause 5. The apparatus of any of clauses 1-3, wherein the frequency domain sequence for a transmission on a single OFDM symbol on a single transmission port is an element wise multiplication of the mother sequence times the sequence selected from the look up table, which is multiplied by a scalar phase rotation that is independent of the sequence selected.
Clause 6. The apparatus of any of clauses 1-5, wherein the frequency domain sequence has a number of elements equal to a number of resource elements times a number of OFDM symbols for the transmission times a number of transmit ports.
Clause 7. The apparatus of any of clauses 1-6, wherein the information message is a payload of a physical uplink control channel (PUCCH) for transmission.
Clause 8. The apparatus of any of clauses 1-7, wherein the mother sequence is selected from a pre-defined set of low peak to average power (PAPR) quadrature phase shift keying (QPSK) sequences based on an identifier of the network node.
Clause 9. A method of wireless communication, comprising: determining a mother sequence based on a network node; selecting a sequence from a look up table based on an information message; generating, per transmission port, a frequency domain sequence that satisfies a property of robustness to frequency selectivity based on the mother sequence, the sequence selected from the look up table, and a phase shift that is independent of the information message; and transmitting the frequency domain sequence on each transmit port.
Clause 10. The method of clause 9, wherein generating the frequency domain sequence comprises performing elementwise multiplication of the mother sequence and the selected sequence per transmit port.
Clause 11. The method of clause 9 or 10, wherein the look up table is trained for the network node using a machine-learning technique to be robust to high channel frequency selectivity.
Clause 12. The method of any of clauses 9-11, wherein transmitting the respective frequency domain sequence on each transmission port comprises transmitting the respective frequency domain sequence on at least two transmission ports.
Clause 13. The method of any of clauses 9-11, wherein the frequency domain sequence for a transmission on a single OFDM symbol on a single transmission port is an element wise multiplication of a single row mother sequence times a single column frequency domain sequence.
Clause 14. The method of any of clauses 9-13, wherein the sequence selected from the look up table has a number of elements equal to a number of resource elements times a number of OFDM symbols for the transmission times a number of transmit ports.
Clause 15. The method of any of clauses 9-14, wherein selecting the sequence from the look up table is based on a payload of a physical uplink control channel (PUCCH) for transmission.
Clause 16. The method of any of clauses 9-15, wherein the mother sequence is selected from a pre-defined set of low peak to average power (PAPR) quadrature phase shift keying (QPSK) sequences based on an identifier of the network node.
Clause 17. An apparatus for wireless communication, comprising: means for determining a mother sequence based on a network node; means for selecting a sequence from a look up table based on an information message; means for generating, per transmission port, a frequency domain sequence that satisfies a property of robustness to frequency selectivity based on the mother sequence, the sequence selected from the look up table, and a phase shift that is independent of the information message; and means for transmitting the frequency domain sequence on each transmit port.
Clause 18. The apparatus of clause 17, wherein the means for generating the frequency domain sequence is configured to perform elementwise multiplication of the mother sequence and the selected sequence per transmit port.
Clause 19. The apparatus of clause 17 or 18, wherein the look up table is trained for the network node using a machine-learning technique to be robust to high channel frequency selectivity.
Clause 20. The apparatus of any of clauses 17-19, wherein selecting the frequency domain sequence from the look up table is based on a payload of a physical uplink control channel (PUCCH) for transmission.
Clause 21. A method of wireless communication, comprising: descrambling a received sequence of a mother sequence elementwise multiplied with a received signal; performing energy detection on the received signal by cross correlating the descrambled signal with each frequency domain sequence in a look up table; identifying a closest correlated frequency domain sequence; and decoding the received sequence as bits corresponding to the closest correlated frequency domain sequence.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus for wireless communication, comprising:
one or more memories, individually or in combination, having instructions; and
one or more processors, individually or in combination, configured to execute the instructions and cause the apparatus to:
determine a mother sequence based on a network node;
select a sequence from a look up table based on an information message;
generate, per transmission port, a frequency domain sequence that satisfies a property of robustness to frequency selectivity based on the mother sequence, the sequence selected from the look up table, and a phase shift that is independent of the information message; and
transmit the frequency domain sequence on each transmit port.

2. The apparatus of claim 1, wherein to generate the frequency domain sequence, the one or more processors are configured to execute the instructions to perform elementwise multiplication of the mother sequence and the selected sequence per transmit port.

3. The apparatus of claim 1, wherein the look up table is trained for the network node using a machine-learning technique to be robust to high channel frequency selectivity.

4. The apparatus of claim 1, wherein to transmit the frequency domain sequence, the one or more processors are configured to execute the instructions to transmit a respective frequency domain sequence on at least two transmission ports, wherein each respective frequency domain sequence is based on a selected sequence per transmit port.

5. The apparatus of claim 1, wherein the frequency domain sequence for a transmission on a single OFDM symbol on a single transmission port is an element wise multiplication of the mother sequence times the sequence selected from the look up table, which is multiplied by a scalar phase rotation that is independent of the sequence selected.

6. The apparatus of claim 1, wherein the frequency domain sequence has a number of elements equal to a number of resource elements times a number of OFDM symbols for the transmission times a number of transmit ports.

7. The apparatus of claim 1, wherein the information message is a payload of a physical uplink control channel (PUCCH) for transmission.

8. The apparatus of claim 1, wherein the mother sequence is selected from a pre-defined set of low peak to average power (PAPR) quadrature phase shift keying (QPSK) sequences based on an identifier of the network node.

9. A method of wireless communication, comprising:
determining a mother sequence based on a network node;
selecting a sequence from a look up table based on an information message;
generating, per transmission port, a frequency domain sequence that satisfies a property of robustness to frequency selectivity based on the mother sequence, the sequence selected from the look up table, and a phase shift that is independent of the information message; and
transmitting the frequency domain sequence on each transmit port.

10. The method of claim 9, wherein generating the frequency domain sequence comprises performing elementwise multiplication of the mother sequence and the selected sequence per transmit port.

11. The method of claim 9, wherein the look up table is trained for the network node using a machine-learning technique to be robust to high channel frequency selectivity.

12. The method of claim 9, wherein transmitting the respective frequency domain sequence on each transmission port comprises transmitting the respective frequency domain sequence on at least two transmission ports.

13. The method of claim 9, wherein the frequency domain sequence for a transmission on a single OFDM symbol on a single transmission port is an element wise multiplication of a single row mother sequence times a single column frequency domain sequence.

14. The method of claim 9, wherein the sequence selected from the look up table has a number of elements equal to a number of resource elements times a number of OFDM symbols for the transmission times a number of transmit ports.

15. The method of claim 9, wherein selecting the sequence from the look up table is based on a payload of a physical uplink control channel (PUCCH) for transmission.

16. The method of claim 9, wherein the mother sequence is selected from a pre-defined set of low peak to average power (PAPR) quadrature phase shift keying (QPSK) sequences based on an identifier of the network node.

17. An apparatus for wireless communication, comprising:
means for determining a mother sequence based on a network node;
means for selecting a sequence from a look up table based on an information message;
means for generating, per transmission port, a frequency domain sequence that satisfies a property of robustness to frequency selectivity based on the mother sequence, the sequence selected from the look up table, and a phase shift that is independent of the information message; and
means for transmitting the frequency domain sequence on each transmit port.

18. The apparatus of claim 17, wherein the means for generating the frequency domain sequence is configured to perform elementwise multiplication of the mother sequence and the selected sequence per transmit port.

19. The apparatus of claim 17, wherein the look up table is trained for the network node using a machine-learning technique to be robust to high channel frequency selectivity.

20. The apparatus of claim 17, wherein selecting the frequency domain sequence from the look up table is based on a payload of a physical uplink control channel (PUCCH) for transmission.
